(19) United States
(12) Patent Application Publication
(10) Pub. No.: US 2010/0071028 A1
(43) Pub. Date: Mar. 18, 2010

(54) Governing Service Identification In A Service Oriented Architecture ('SOA') Governance Model

(75) Inventors: William A. Brown, Raleigh, NC (US); Kerrie L. Holley, Montara, CA (US); Garrison A. Moore, Uxbridge (CA); William J. Tegan, Oakland, CA (US)

Correspondence Address: BIGGERS & OHANIAN (END), C/O BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/233,156

(22) Filed: Sep. 18, 2008

(51) Int. Cl. H04L 9/00

(52) U.S. Cl. 726/1

(57) ABSTRACT

Methods and systems for governing service identification in an SOA governance model according to embodiments of the present invention are provided. Embodiments include receiving a set of input parameters for identifying candidate services for the SOA; determining whether the set of input parameters comply with a predetermined input parameter validation policy. If the set of input parameters comply with a predetermined input parameter validation policy, governing service identification includes identifying in dependence upon the set of input parameters one or more candidate services available for the SOA in existing SOA business applications and determining whether each candidate services available in existing SOA business applications comply with a predetermined service selection policy. If one of the candidate services available in existing SOA business applications complies with a predetermined service selection policy, governing service identification includes selecting the candidate service as a service available for the SOA and communicating the identification of that selected service to relevant stakeholders in the SOA.

### BACKGROUND OF THE INVENTION

1. Field of the Invention

The field of the invention is data processing, or, more specifically, methods and systems for governing service identification in a Service Oriented Architecture (‘SOA’) governance model.

2. Description of Related Art

Service Oriented Architecture (‘SOA’) is an architectural style that guides all aspects of creating and using business processes, packaged as services, throughout their lifecycle, as well as defining and provisioning the IT (‘information technology’) infrastructure that allows different applications to exchange data and participate in business processes loosely coupled from the operating systems and programming languages underlying those applications. SOA represents a model in which functionality is decomposed into distinct units (services), which can be distributed over a network and can be combined together and reused to create business applications. These services communicate with each other by passing data from one service to another, or by coordinating an activity between two or more services. The concepts of Service Oriented Architecture are often seen as built upon, and the evolution of, the older concepts of distributed computing and modular programming. Although services and a business's SOA architecture are often strictly defined, governance of an SOA, implementation of an SOA, operation of an SOA, and management of an SOA is often not defined. A defined model of governance, however, may increase effectiveness and efficiency in implementing, operating, and managing a business's SOA, thereby providing savings to the business.

### SUMMARY OF THE INVENTION

Methods and systems for governing service identification in an SOA governance model according to embodiments of the present invention are provided. Embodiments include receiving a set of input parameters for identifying candidate services for the SOA; determining whether the set of input parameters comply with a predetermined input parameter validation policy. If the set of input parameters comply with a predetermined input parameter validation policy, governing service identification includes identifying in dependence upon the set of input parameters one or more candidate services available for the SOA in existing SOA business applications and determining whether each candidate services available in existing SOA business applications comply with a predetermined service selection policy. If one of the candidate services available in existing SOA business applications complies with a predetermined service selection policy, governing service identification includes selecting the candidate service as a service available for the SOA and communicating the identification of that selected service to relevant stakeholders in the SOA.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for governing a Service Oriented Architecture (‘SOA’) according to embodiments of the present invention.

FIG. 2 sets forth a flow chart illustrating an exemplary method for governing an SOA according to embodiments of the present invention.

FIG. 3 sets forth a flow chart illustrating a further exemplary method for governing an SOA according to embodiments of the present invention.

FIG. 4 sets forth a flow chart illustrating a further exemplary method for governing an SOA according to embodiments of the present invention.

FIG. 5 sets forth a flow chart illustrating a further exemplary method for governing an SOA according to embodiments of the present invention.

FIG. 6 sets forth a flow chart illustrating a further exemplary method for governing an SOA according to embodiments of the present invention.

FIG. 7 sets forth an exemplary method of governing service identification in a Service Oriented Architecture (‘SOA’) governance model.

FIG. 8 sets forth a flow chart illustrating an exemplary method for identifying in dependence upon the set of input parameters one or more candidate services for the SOA available in existing SOA business applications.

FIG. 9 sets forth a block diagram of additional aspects of identifying (712) in dependence upon the set of input parameters one or more candidate services available for the SOA in existing SOA business applications according to embodiments of the present invention.

### DETAILED DESCRIPTION OF EXEMPLARY EMBODIMENTS

### Governing A Service Oriented Architecture (‘SOA’)

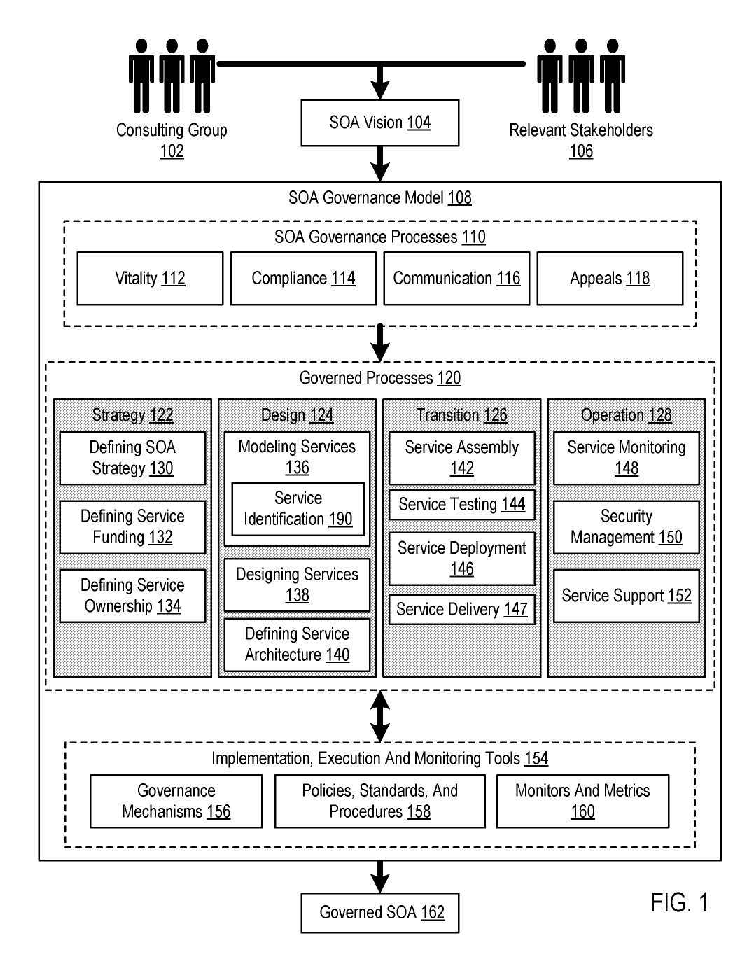

Exemplary methods and systems for governing an SOA in accordance with the present invention are described with reference to the accompanying drawings, beginning with FIG. 1. FIG. 1 sets forth a block diagram of a system for governing a Service Oriented Architecture (‘SOA’) according to embodiments of the present invention. SOA is an architectural style that guides all aspects of creating and using business processes, packaged as services, throughout their lifecycle, as well as defining and provisioning the information technology (‘IT’) infrastructure that allows different applications to exchange data and participate in business processes loosely coupled from the operating systems and programming languages underlying those applications. SOA represents a model in which functionality is decomposed into distinct units, called services, which can be distributed over a network, can be combined together, and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

The system of FIG. 1 includes an SOA governance model (108) that provides parameters used in governing a business's SOA, that is, a governed SOA (162). An SOA governance model may be established through use of a consulting group (102), using software tools and business artifacts, and relevant stakeholders (106) of a business. A consulting group may include one or more individuals that guide members of a business in establishing and implementing an SOA governance model. Such individuals typically are not members of the business. Consulting groups often work closely with relevant stakeholders of the business in establishing and implementing an SOA governance model.

A relevant stakeholder (106) of a business is an individual or party that affects, or can be affected by, a business's actions. “Relevant stakeholders,” as the term is used in the specification, refers to stakeholders which are most directly affected by a business's actions with respect to SOA and often have decision making authority with regard to one or more aspects of the SOA governance model. Although only consulting groups and relevant stakeholders are described here with respect to implementing and operating a governance model in accordance with embodiments of the present invention, readers of skill in the art will immediately recognize that many other individuals or group of individuals associated with a business may take part in implementing and operating some or more aspects such a governance model and each such individual or group of individuals and their actions are also well within the scope of the present invention.

The exemplary SOA governance model (108) of FIG. 1 may be implemented and operated according to an SOA vision (104) that may be defined by the consulting (102) and the relevant stakeholders (106) of the business. That is, a consulting group may be used to guide relevant stakeholders through a process of identifying an SOA vision which may be used to define not only primary boundaries of the business's SOA, but also a governance model for the SOA. An SOA vision (104) is a general and broad definition of an SOA strategy to be accomplished through use of an SOA. An example of such an SOA strategy which may be accomplished through use of an SOA, is to reduce redundancy in the use of different software applications that provide similar functionality to different organizational entities of the business. Consider, for example, that a retail sales department and an online sales department use different software applications to provide the similar function of receiving and processing customer orders. An SOA vision may outline business goals of the SOA that may be implemented that reduce such redundancy by providing a single service of customer order receipt and processing to both the retail sales department and the online sales department of the business.

As mentioned above, an SOA governance model (108) provides parameters used in governing a business's governed SOA (162). The exemplary SOA governance model (108) of FIG. 1, for example, includes several SOA governance processes (110). An SOA governance process (110) is a processes that when executed governs one or more governed SOA processes (110), the governed processes typically used in implementing, operating, maintaining, and managing an SOA for a business. That is, the governance processes, when executed, effect governance of the typical implementation, operation, maintenance, and management of an SOA for a business.

The exemplary SOA governance model (108) of FIG. 1 the SOA includes a vitality (112) governance processes, a compliance (114) governance process, a communication (116) governance processes, and an appeals (118) governance process. The vitality (112) governance process maintains the applicability of the SOA governance model. The vitality process ensures that the governance model is current, reflecting current business and information technology and strategy, and also refines other governance processes and governance mechanisms to ensure continued usage and relevance of the governance model.

The compliance (114) governance process governs the review and approval processes used in implementing and managing services within an SOA. The governance processes includes providing criteria defined in the establishment of an SOA governance model to guide such review and approval processes. Such criteria may include a business's principles, standards, defined business roles, and responsibilities associated with those defined business roles.

The communication (116) governance process governs communication of SOA vision, SOA plans, and the SOA governance model to members of the business for educating such members. The communication governance process ensures that governance is acknowledged and understood throughout a business and also provides, to members of the business, environments and tools for easy access and use of information describing an SOA governance model.

The appeals (118) governance process enables members of a business to appeal SOA decisions. This appeals governance process therefore also provides exceptions to business policies, information technology policies, and other criteria that must typically be met within SOA decision-making processes.

As mentioned above, each of the governance processes when executed governs one or more governed processes. A governed process is a process used in implementing, operating, maintaining, and managing an SOA for a business. The exemplary SOA governance model (108) of FIG. 1 includes categories of governed processes (122, 124, 126, 128). Each category represents an area of SOA implementation, operation, maintenance, and management carried out by the governed processes included in the category.

The categories of governed processes in the example of FIG. 1 include strategy (122), design (124), transition (126), and operation (128). Processes included in the category of strategy (122) generally carry out an initial planning of service implementation. Examples of governed processes included in the category of strategy include a process for defining SOA strategy (130), defining service funding (132), and defining service ownership (134).

Processes included in the category of design (124) generally carry out identification and definition of particular services for an SOA. Examples of governed processes included in the category of design include a process for modeling services (136), designing services (138), and defining service architecture (140). In the example of FIG. 1 the governed process of modeling services (136) includes the process of service identification (190). Service identification is the process of identifying from existing business functions, and other sources services available for use in an SOA for a business. The process of service identification may be governed according to embodiments of the present invention. Governing service identification in an SOA governance model according to embodiments of the present invention include receiving a set of input parameters for identifying candidate services for the SOA; determining whether the set of input parameters comply with a predetermined input parameter validation policy. If the set of input parameters comply with a predetermined input parameter validation policy, governing service identification includes identifying in dependence upon the set of input parameters one or more candidate services available for the SOA in existing SOA business applications and determining whether each candidate services available in existing SOA business applications comply with a predetermined service selection policy. If one of the candidate services available in existing SOA business applications complies with a predetermined service selection policy, governing service identification includes selecting the candidate service as a service available for the SOA and communicating the identification of that selected service to relevant stakeholders in the SOA.

Processes included in the category of transition (126) generally carry out implementation of services in an SOA. Examples of governed processes included in the category of transition (126) include a process for service assembly (142), service testing (144), service deployment (146), and service delivery (147). Processes included in the category of operation (128) generally carry out management and monitoring of services operating within an SOA. Examples of governed processes included in the category of operation (128) include a process for service monitoring (148), security management (150), and service support (152).

The SOA governance processes (110) of FIG. 1 are executed and implemented by one or more implementation, execution and monitoring tools (154). Such implementation tools may include governance mechanisms (156). Governance mechanisms (156) may include one or more individuals, organizational entities, and business infrastructure to carry out governance according to the governance model (108). Such individuals may include relevant stakeholders, committees, or boards responsible for carrying out such governance. Organizational entities may include, for example, a board of directors, management groups, departments within a business, and the like. Business infrastructure may include available human labor, software applications, database management systems, computer technology, funding, and other types of business infrastructure as will occur to those of skill in the art. Different governance mechanisms (156) may be responsible for carrying out governance of different categories (122,124,126,128) of governed processes (120).

Other exemplary implementation and execution tools (154) in the exemplary system of FIG. 1 include policies, standards, and procedures (158). Policies, standards, and procedures (158) are embodiments of a business's overall business principles and are typically used in guiding decision-making in many of the governed processes (120). That is, policies, standards, and procedures (158) are compliance requirements, defined according to the business's SOA.

Other exemplary implementation, execution, and monitoring tools (154) in the exemplary system of FIG. 1 include monitors and metrics (160). Monitors are typically used to gather data describing performance of governed processes (120) and SOA governance processes (110). The data describing performance of governed processes and SOA governance processes may be compared to specified metrics in order to determine whether the performance of the governed processes and SOA governance processes is weak or strong. The metrics may also be used to identify particular steps of governed processes (120) and SOA governance processes (110) are ripe for improvement. As such monitors and metrics may be used to increase the efficiency and overall effectiveness of not only the governed processes typically used in implementing, operating, maintaining, and managing an SOA (162), but may also be used to increase the efficiency and overall effectiveness of the SOA governance processes (110) that govern such governed processes (120).

The arrangement of governance processes, governed processes, implementation and execution tools making up the exemplary system illustrated in FIG. 1 are for explanation, not for limitation. Systems useful according to various embodiments of the present invention may include additional computer technology, software applications, servers, routers, devices, architectures, organizational entities, and business members not shown in FIG. 1, as will occur to those of skill in the art.

Networks in such systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms.

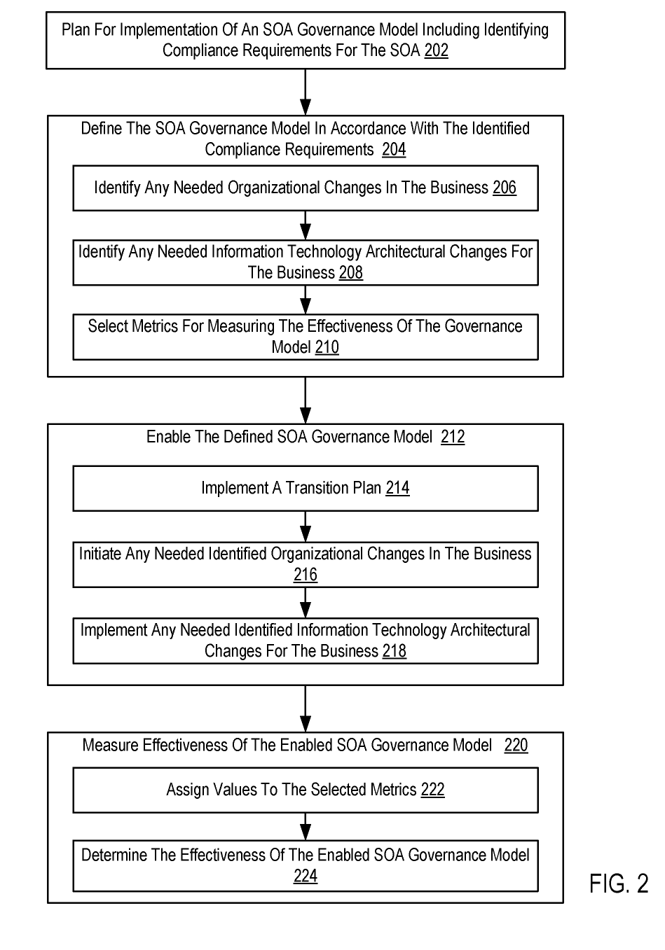

For further explanation, FIG. 2 sets forth a flow chart illustrating an exemplary method for governing an SOA according to embodiments of the present invention. The method of FIG. 2 includes planning (202) for implementation of an SOA governance model for governing a business's SOA. An SOA governance model provides parameters used in governing a business's SOA. In the method of FIG. 2, planning (202) for implementation of an SOA governance model for governing a business's SOA includes identifying compliance requirements for the SOA. Compliance requirements typically include criteria, principles, standards, business principles, and information technology principles of a business with which a businesses SOA, and therefore governance of the SOA, must typically comply. In some cases, however, exceptions to the compliance requirements may be made in accordance with governance processes defined within the SOA governance model. Planning (202) for implementation of an SOA governance model for governing a business's SOA may be carried out by one or more business members, one or more governance software applications, web servers, spreadsheets, databases, computers, networks, aggregations of software and hardware, and other tools and artifacts as will occur to those of skill in the art.

The method of FIG. 2 also includes defining (204) the SOA governance model in accordance with the identified compliance requirements. In the method of FIG. 2 defining (204) the SOA governance model in accordance with the identified compliance requirements includes identifying (206) any needed organizational changes in the business, identifying (208) any needed information technology architectural changes for the business, and selecting (210) metrics for measuring the effectiveness of the governance model. Organizational changes in the business may include restructuring of business departments, reorganization of a board of directors, hiring new employees, or removing current employees. Information Technology (‘IT’) architectural changes for a business may include modifying hardware infrastructure such as adding or removing a network or a data center. IT architectural changes may also include modifying software infrastructure for the business such as unifying the currently installed operating system on each of the business's computers, updating database management software, installing one or more software applications, and so on. Defining (204) the SOA governance model in accordance with the identified compliance requirements may be carried out by one or more business members, one or more governance software applications, web servers, spreadsheets, databases, computers, networks, aggregations of software and hardware, and other tools as will occur to those of skill in the art.

The method of FIG. 2 also includes enabling (212) the defined SOA governance model. In the method of FIG. 2, enabling (212) the defined SOA governance model includes implementing (214) a transition plan, initiating (216) any needed identified organizational changes in the business, and implementing (218) any needed identified information technology architectural changes for the business. A transition plan is a plan describing the execution of a modification in a business's SOA or in the business's SOA governance. Enabling (212) the defined SOA governance model may be carried out by one or more business members, one or more governance software applications, web servers, spreadsheets, databases, computers, networks, aggregations of software and hardware, and other tools as will occur to those of skill in the art.

The method of FIG. 2 also includes measuring (220) effectiveness of the enabled SOA governance model. In the example of FIG. 2 measuring (220) effectiveness of the enabled SOA governance model includes assigning (222) values to the selected metrics and determining (224), in dependence upon the values of the selected metrics, the effectiveness of the enabled SOA governance model. Measuring (220) effectiveness of the enabled SOA governance model may be carried out by one or more business members, one or more governance software applications, web servers, spreadsheets, databases, computers, networks, aggregations of software and hardware, and other tools as will occur to those of skill in the art.

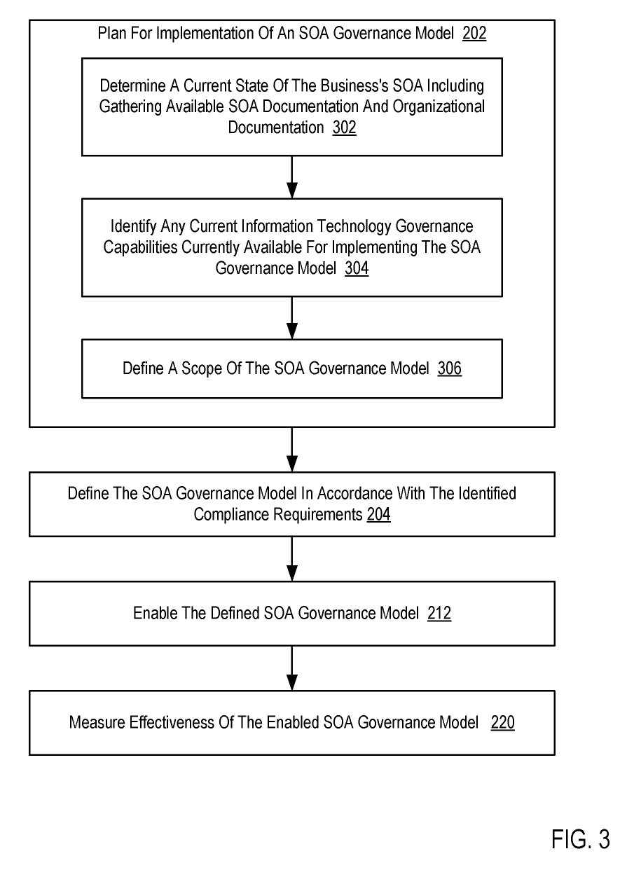

For further explanation, FIG. 3 sets forth a flow chart illustrating a further exemplary method for governing an SOA according to embodiments of the present invention. The method of FIG. 3 is similar to the method of FIG. 2 in that the method of FIG. 3 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 3 differs form the method of FIG. 2, however, in that in the method of FIG. 3, planning (202) for the implementation of an SOA governance model for governing business's SOA includes determining (302) a current state of the business's SOA including gathering available SOA documentation and organizational documentation, identifying (304) any current information technology governance capabilities currently available for implementing the SOA governance model, and defining (306) a scope of the SOA governance model.

In the method of FIG. 3, determining (302) a current state of the business's SOA including gathering available SOA documentation and organizational documentation may be carried out by identifying business principles of the business for use in the SOA governance model, identifying information technology principles of the business for use in the SOA governance model, and determining the effectiveness of current information technology governance procedures in governing current business principles and current information technology principles. A consulting group and relevant stakeholders may use software applications, artifacts, computer hardware, and other devices to carry out such identification and determination.

In the method of FIG. 3, identifying (304) any current information technology governance capabilities currently available for implementing the SOA governance model may be carried out by determining, in dependence upon a Control Objectives for Information and related Technology (‘COBIT’) framework, existing governance capabilities of the business; determining, in dependence upon a Service Integration Maturity Model (‘SIMM’), existing governance capabilities of the business; and conducting a change readiness survey to identify existing information technology governance capabilities. COBIT is a set of “best practices” or a framework for information technology management created by the Information Systems Audit and Control Association (‘ISACA’), and the IT Governance Institute (‘ITGI’). COBIT provides managers, auditors, and IT user with a set of generally accepted measures, indicators, and processes to assist the managers, auditors, and IT users in maximizing the benefits derived through the use of information technology and developing appropriate IT governance and control. SIMM is a model used to increase maturity of service integration and SOA adoption through all areas of a business. A change readiness survey is a survey used to identify, evaluate, and monitor, the readiness of the business to accept and adopt changes required by SOA governance.

In the method of FIG. 3 defining (306) a scope of the SOA governance model may be carried out by identifying processes to be governed according to the business's SOA governance model, and identifying prospective governance mechanisms. Governance mechanisms are referred to here as “prospective” because the identified governance mechanisms may or may not be used when the governance model is implemented. Each prospective governance mechanism, however, is capable of administering SOA governance processes that govern the identified governed processes. As mentioned above, governance mechanisms may include one or more individuals, organizational entities, and business or technology infrastructure to carry out governance according to the governance model.

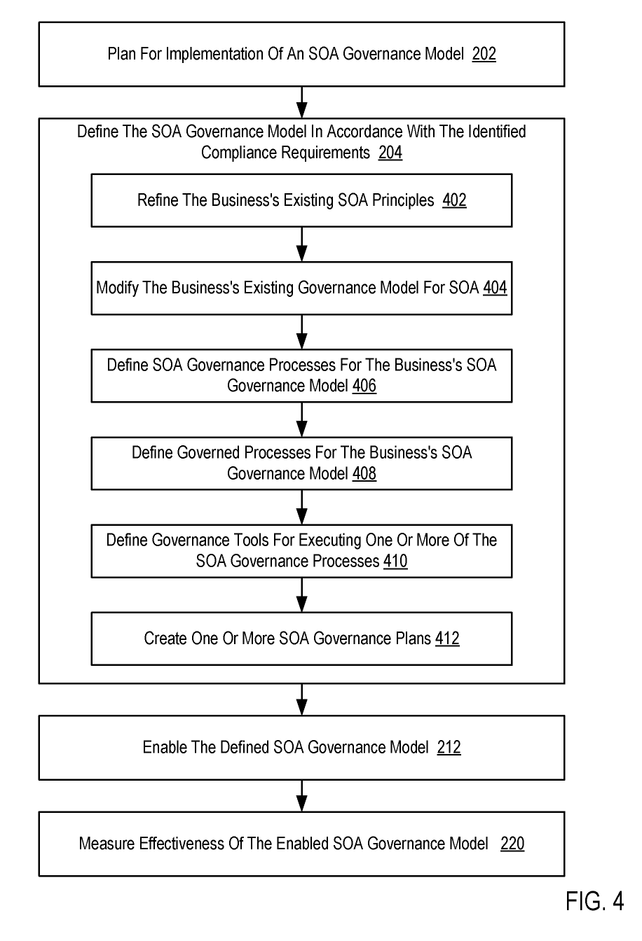

For further explanation, FIG. 4 sets forth a flow chart illustrating a further exemplary method for governing an SOA according to embodiments of the present invention. The method of FIG. 4 is similar to the method of FIG. 2 in that the method of FIG. 4 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 4 differs form the method of FIG. 2, however, in that in the method of FIG. 4 defining (204) the SOA governance model in accordance with the identified compliance requirements includes refining (402) the business's existing SOA principles; modifying (404) the business's existing governance model for SOA; defining (406) SOA governance processes for the business's SOA governance model, the SOA governance processes comprising processes that govern a set of governed processes in a business's SOA; defining (408) governed processes for the business's SOA governance model, each governed process capable of governing a portion of a business's SOA, each governed processes governed by one or more SOA governance processes; defining (410) governance tools for executing one or more of the SOA governance processes; and creating (412) one or more SOA governance plans.

In the method of FIG. 4, refining (402) the business's existing SOA principles may be carried out by updating the business's existing SOA business principles according to a business's SOA vision and updating the business's existing SOA information technology principles, policies, or standards according to the business's SOA vision. In some cases, a business may have existing SOA business principles prior to implementation of SOA governance. In other cases, the business's SOA is implemented in conjunction with the SOA governance model. For the former, existing SOA business principles may be modified according to the business's currently identified SOA vision which may vary when an SOA governance model is implemented. Also in some cases, a business may have existing SOA information technology principles, policies, and standards prior to the implementation of an SOA governance model. These existing SOA information technology principles, policies, and standards may also be modified in accordance with the business's currently identified SOA vision.

In the method of FIG. 4, modifying (404) the business's existing governance model for SOA may be carried out by redefining processes used in the business's existing governance model according to the business's SOA vision. In some cases a business may be operating within an existing governance model that governs aspects of the business other than SOA, such as for example, and existing IT governance model. Such an existing governance model may be modified for SOA by redefining the existing governance model according to the business's SOA vision and strategy.

In the method of FIG. 4, defining (408) governed processes for the business's SOA governance model may be carried out by selecting, from a preconfigured set of prospective governed processes in dependence upon a business's SOA vision, one or more prospective governed processes to be used as governed processes in the business's SOA governance model; developing, in dependence upon the business's SOA vision, one or more additional governed processes to be used as governed process in the business's SOA governance model; defining, for each selected and developed governed process, a policy for managing the governed process; and defining, for each governed process in dependence upon the governed processes defined policy, metrics for measuring the effectiveness of the governed process. In some cases a consulting group may provide a preconfigured set of prospective governed processes to relevant stakeholders to enable the relevant stakeholders to begin defining processes to be governed by an SOA governance model. In other cases, a consulting group and relevant stakeholders may create, define, and implement new processes to be governed by the business's SOA governance model. The policies defined for each of the governed processes typically identify parameters, based on the business principles, SOA principles, and IT principles, with which each governed process must comply.

In the method of FIG. 4, defining (410) governance tools for executing one or more of the SOA governance processes may be carried out by: identifying one or more of the business's current governance tools currently employed by the business; modifying one or more of the identified governance tools for use as governance tools for executing the business's SOA governance model; establishing one or more of the identified governance tools as governance tools for executing one or more SOA governance processes; establishing one or more additional governance tools for use as governance tools for executing one or more SOA governance processes, the additional governance tools not currently employed in the business's existing governance model; and defining metrics for measuring the effectiveness of each of the governance tools for executing one or more SOA governance processes. A governance tool includes any available business asset used in carrying out a governance process. Such available business assets may include one or more business members, organizational entities, computer technology, information technology infrastructure, artifacts, and other available assets as will occur to those of skill in the art.

In the method of FIG. 4, creating (412) one or more SOA governance plans may be carried out by creating an SOA governance support plan; creating an organizational change management plan including establishing one or more metrics for measuring effectiveness of an organization defined according to an organization change management plan; and creating an SOA transition plan. An SOA governance support plan may include a communication plan that defines methods of communicating SOA vision, standards, principles, and the like to members of a business. An SOA governance support plan may also include a mentoring plan that outlines methods for mentoring users of services in the SOA. An SOA governance support plan may also include an education and training plan that describes the training and education made available by a business for users and developers of service in the business's SOA.

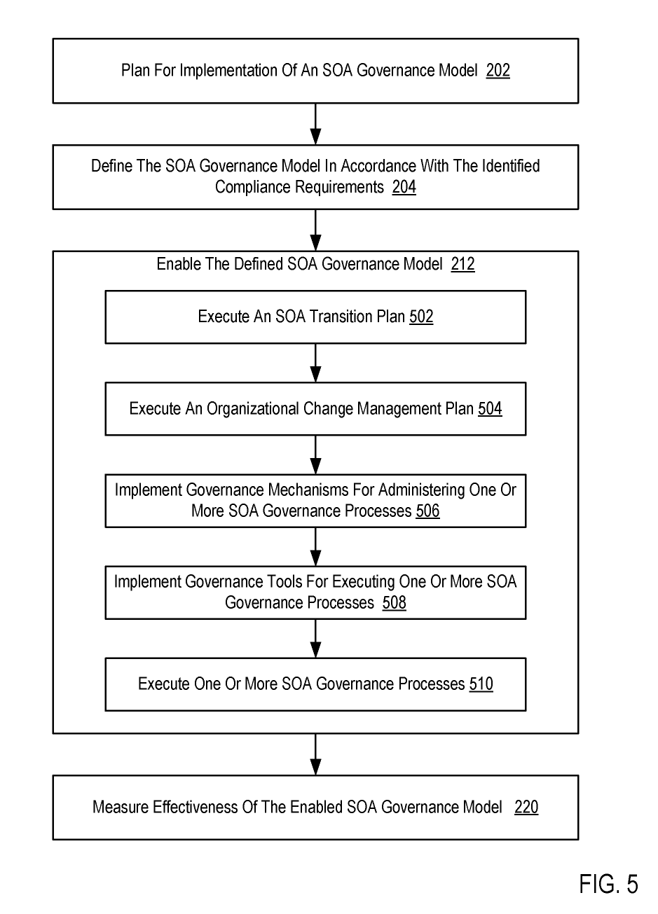

For further explanation, FIG. 5 sets forth a flow chart illustrating a further exemplary method for governing an SOA according to embodiments of the present invention. The method of FIG. 5 is similar to the method of FIG. 2 in that the method of FIG. 5 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 5 differs from the method of FIG. 2, however, in that in the method of FIG. 5, enabling (212) the defined SOA governance model includes executing (502) an SOA transition plan; executing (504) an organizational change management plan; implementing (506) governance mechanisms for administering one or more SOA governance processes that govern one or more governed processes implementing (508) governance tools for executing one or more SOA governance processes; and executing (510), by the governance mechanisms through use of governance tools, one or more SOA governance processes. As mentioned above, an SOA transition plan is a plan describing the execution of a modification in a business's SOA or in the business's SOA governance.

An organizational change management plan is a plan describing the steps of managing an organizational change in the business where such an organizational change aids in the governing of a business's SOA. Executing an organizational change management plan may be carried out by one or more members of the business having responsibility for carrying out such a change in organizational structure. Executing an organizational change management plan may include allocating resources, hiring new employees, restructuring existing business organizations, defining new responsibilities for current employees, and so on as will occur to readers of skill in the art.

Governance tools may include any available business asset used in carrying out a governance process. Governance tools such as IT tools, may be implemented by installing computer hardware such as blade servers, configuring computer hardware including configuring data communications networks, installing software, configuring database systems, installing plug-ins to existing software packages and so on as will occur to readers of skill in the art.

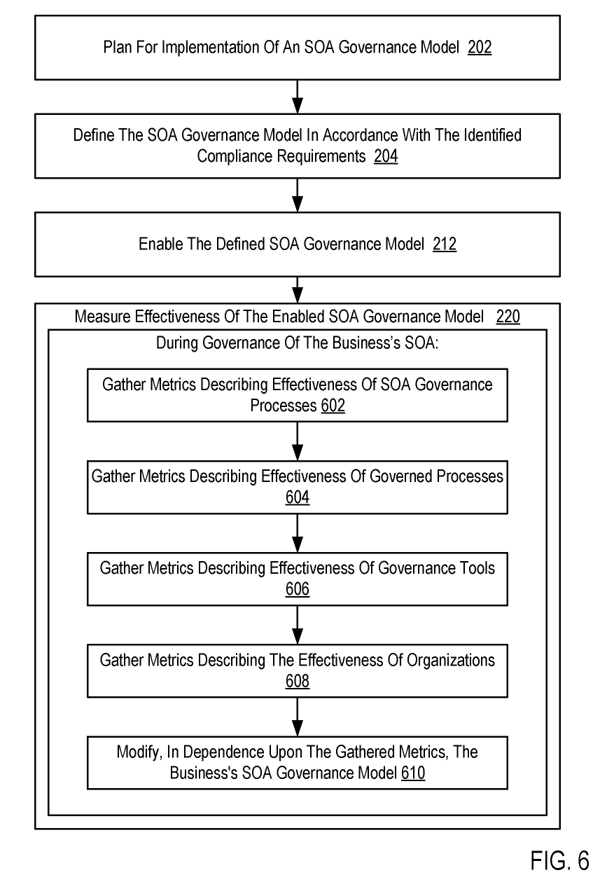

For further explanation, FIG. 6 sets forth a flow chart illustrating a further exemplary method for governing an SOA according to embodiments of the present invention. The method of FIG. 6 is similar to the method of FIG. 2 in that the method of FIG. 6 also includes planning (202) for implementation of an SOA governance model for governing a business's SOA including identifying compliance requirements for the SOA, defining (204) the SOA governance model in accordance with the identified compliance requirements, enabling (212) the defined SOA governance model, and measuring (220) effectiveness of the enabled SOA governance model.

The method of FIG. 6 differs from the method of FIG. 2, however, in that in the method of FIG. 2, measuring (220) effectiveness of the enabled SOA governance model includes gathering (602) metrics describing effectiveness of SOA governance processes; gathering (604) metrics describing effectiveness of governed processes; gathering (606) metrics describing effectiveness of governance tools; gathering (608) metrics describing the effectiveness of organizations defined according to the business's organization change management plan; and modifying (610), in dependence upon the gathered metrics, the business's SOA governance model, all during governance of the business's SOA according to the enabled SOA governance model.

Metrics describing effectiveness may include surveys of business members involved in carrying out governance processes, data recorded by computer systems identifying decision making statistics, such as the amount of time required to make a decision, or the number of parties involved in the decision making process, and so on as will occur to those of skill in the art. Metrics typically describe a level of service. Metrics that measure a service level are compared to a baseline service level, a level of service which a business desires to provide through SOA and SOA governance. Metrics may therefore be used to identify areas of SOA or SOA governance which may be improved to more closely provide the baseline service level of business.

From time to time during governance of the business's SOA, the SOA governance model may be improved. Such improvement is enabled by gathering various metrics, assigning values to those gathered metrics, comparing the assigned values of the gathered metrics to criteria and identifying areas where improvement is needed. Once areas of needed improvement are identified, a consulting group and relevant stakeholders, such as for example, an SOA governance board, may improve the SOA governance model in the areas identified.

### Governing Service Identification In A Service Oriented Architecture (‘SOA’) Governance Model

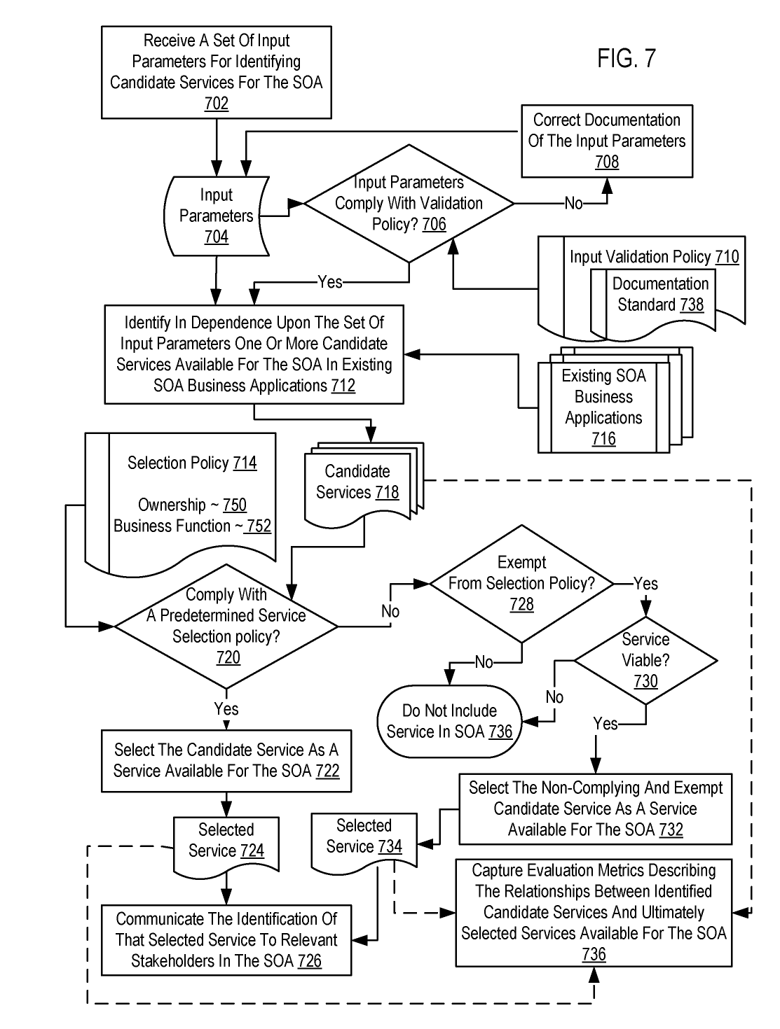

FIG. 7 sets forth an exemplary method of governing service identification in a Service Oriented Architecture (‘SOA’) governance model. The method of FIG. 7 includes receiving (702) a set of input parameters (704) for identifying candidate services for the SOA (718). The set of input parameters (704) are typically implemented as a set of documented aspects of the business for whom an SOA is to be implemented and therefore, the business, for whom the identification of services is to be governed according to embodiments of the present invention. The set of input parameters (704) for identifying candidate services for the SOA (718) may include a model of the businesses implementing the SOA, a model of the industry of the business, a model of existing services in any currently implemented business applications or applications in an existing SOA, a model of the ownership of existing services in the currently implemented business applications or applications in an existing SOA, any documentation describing the funding available for services to be identified for the SOA, or any other input parameter that will occur to those of skill in the art.

A candidate service for the SOA (718) is a service may be identified as a service for implementation in the SOA. A such a candidate service (718) is often implemented in one or more existing SOA business application and the candidate service may be identified as a service for use for the SOA according to the method of FIG. 7 if it is later determined that the candidate service complies with service selection policies or is exempt from such service selection policies and such an exempt service is also viable as described below. As will occur to those of skill in the art, not all candidate services that exist in existing SOA business applications will be identified as services selected for the business' SOA according to the method of FIG. 7.

Receiving (702) a set of input parameters (704) for identifying candidate services for the SOA (718) may be carried out by requesting one or more input parameters from business information sources such as various relevant stakeholders, consultants in a consulting group, appropriate subject matter experts, or other business information sources and receiving from such business information sources one or more of the requested input parameters. Receiving (702) a set of input parameters (704) for identifying candidate services for the SOA (718) may be carried out by one or more business members, one or more governance software applications, web servers, spreadsheets, databases, computers, networks, aggregations of software and hardware, and other tools as will occur to those of skill in the art.

The method of FIG. 7 includes determining (706) whether the set of input parameters (704) comply with a predetermined input parameter validation policy (710). A predetermined input validation policy is policy that identifies whether the received input parameters are sufficient to identify candidate services in existing SOA business applications according to well-known SOA service identification methods, such as for example, those using the Service Oriented Modeling and Architecture (‘SOMA’) methodology. SOMA refers to a generalized methodology for service modeling necessary to design and create SOA. SOMA implements service-oriented analysis and design through the identification, specification and realization of services, components that realize those services (often known as “service components”), and process flows that can be used to compose services. SOMA builds on current techniques in areas such as domain analysis, functional areas grouping, variability-oriented analysis process modeling, component-based development, object-oriented analysis and design and use case modeling. SOMA introduces new techniques such as goal-service modeling, service model creation and a service litmus test to help determine the granularity of a service.

Determining (706) whether the set of input parameters (704) comply with a predetermined input parameter validation policy (710 may be carried out by one or more business members, one or more governance software applications, web servers, spreadsheets, databases, computers, networks, aggregations of software and hardware, and other tools as will occur to those of skill in the art.

In the method of FIG. 7, the input validation policy (710) is implemented as a documentation standard (738). A documentation standard establishes a minimum requirement for the documentation of the input parameters (704) used to identify candidate services (718). That is, those input parameters that have not been documented in enough detail to be useful in identifying candidate services according to well-known SOA service identification methods, the input parameters will not meet the documentation standard of FIG. 7. In the method of FIG. 7, determining (706) whether the set of input parameters (704) comply with a predetermined input parameter validation policy (710) therefore includes determining whether the input parameters (704) comply with a documentation standard (738). Determining whether the input parameters (704) comply with a documentation standard (738) may be carried out by determining whether the input parameters (704) that have not been documented in enough detail to be useful in identifying candidate services according to well-known SOA service identification methods.

In the method of FIG. 7, if the input parameters do not comply with the documentation standard (738), the method of FIG. 7 includes correcting (708) documentation of the input parameters (704). Correcting (708) documentation of the input parameters (704) may be carried out by requesting that one or more business information sources, such as various relevant stakeholders, consultants in a consulting group, appropriate subject matter experts, or other business information sources improve the documentation of one or more received input parameters. Correcting (708) documentation of the input parameters (704) may be carried out by one or more business members, one or more governance software applications, web servers, spreadsheets, databases, computers, networks, aggregations of software and hardware, and other tools as will occur to those of skill in the art.

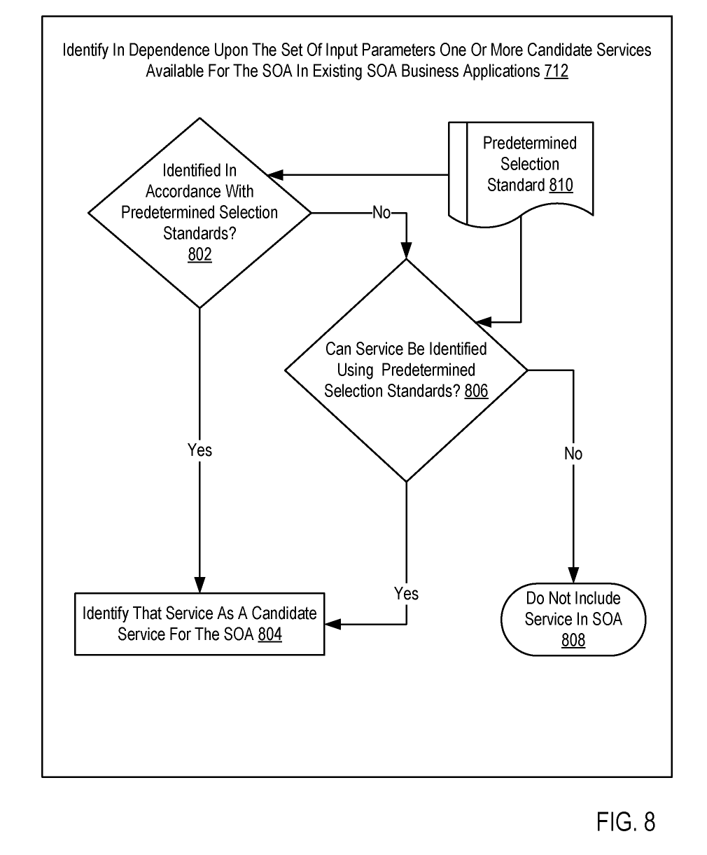

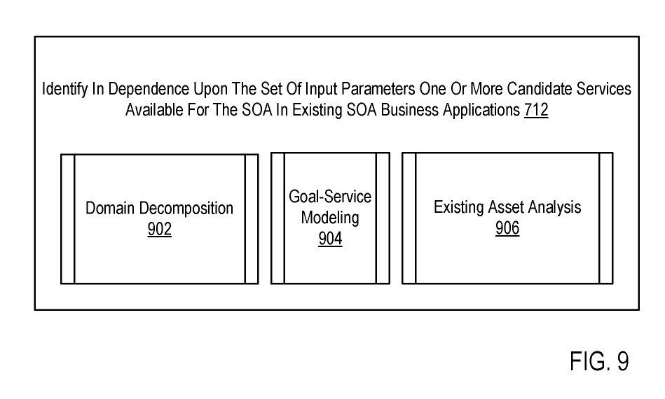

If the set of input parameters comply with a predetermined input parameter validation policy (710), the method of FIG. 7 includes identifying (712) in dependence upon the set of input parameters (704) one or more candidate services (718) available for the SOA in existing SOA business applications (716). Identifying (712) in dependence upon the set of input parameters (704) one or more candidate services (718) available for the SOA in existing SOA business applications (716) may be carried out according to one or more well-known SOA service identification methods, such as for example, those using the Service Oriented Modeling and Architecture (‘SOMA’) methodology as described below with reference to FIG. 8. Identifying (712) in dependence upon the set of input parameters (704) one or more candidate services (718) available for the SOA in existing SOA business applications (716) may be carried out may include includes domain decomposition (902) and existing asset analysis (906) as discussed below with reference to FIG. 9. Identifying (712) in dependence upon the set of input parameters (704) one or more candidate services (718) available for the SOA in existing SOA business applications (716) may be carried out by one or more business members, one or more governance software applications, web servers, spreadsheets, databases, computers, networks, aggregations of software and hardware, and other tools as will occur to those of skill in the art.

The method of FIG. 7 also includes determining (720) whether each candidate services (718) available in existing SOA business applications (716) complies with a predetermined service selection policy (714). A predetermined service selection policy (714) is a set of rules governing the selection of services for use in the SOA from those candidate services identified by well-known SOA service identification methods. Such rules include rules governing the selection a service based upon, for example, the ownership of the candidate service, whether the candidate service functions across business units of the SOA, whether the candidate service performs appropriate business functions for the SOA and other selection rules that will occur to those of skill in the art.

In the example of FIG. 7, the predetermined service selection policy (714) includes an ownership rule (750) requiring that the candidate service be owned by one or more predetermined entities to comply with the service selection policy (714). The predetermined service selection policy (714) of FIG. 7 also includes an business function rule (752) requiring that the candidate service perform one or more predetermined business functions to comply with the service selection policy (714). The use of the ownership rule and the business function rule in the example of FIG. 7 is for explanation and not for limitation. In fact, service selection policies according to embodiments of the present invention may include many different kinds of rules and all such rules are well within the scope of the present invention.

Determining (720) whether each candidate service (718) available in existing SOA business applications (716) complies with a predetermined service selection policy (714) may be carried out by one or more business members, one or more governance software applications, web servers, spreadsheets, databases, computers, networks, aggregations of software and hardware, and other tools as will occur to those of skill in the art.

If one of the candidate services available in existing SOA business applications complies with a predetermined service selection policy, the method of FIG. 7 includes selecting (722) the candidate service (718) as a service available for the SOA (724) and communicating (726) the identification of that selected service (724) to relevant stakeholders in the SOA. Selecting (722) the candidate service (718) as a service available for the SOA (724) includes identifying and documenting the selected candidate service as a service selected as available for the SOA. Selecting (722) the candidate service (718) as a service available for the SOA (724) may be carried out by one or more business members, one or more governance software applications, web servers, spreadsheets, databases, computers, networks, aggregations of software and hardware, and other tools as will occur to those of skill in the art.

Communicating (726) the identification of that selected service (724) to relevant stakeholders in the SOA is typically carried out in accordance with a communication plan and the identified selected service is typically communicated to the appropriate stakeholders and often communicated by the process owner. Communicating (726) the identification of that selected service (724) to relevant stakeholders in the SOA may be carried out by one or more business members, one or more governance software applications, web servers, spreadsheets, databases, computers, networks, aggregations of software and hardware, and other tools as will occur to those of skill in the art.

If one of the candidate services available (718) in existing SOA business applications does not comply with a predetermined service selection policy (714), the method of FIG. 7 includes determining (728) whether the non-complying candidate service should be exempt from the predetermined service selection policy (714). Determining (728) whether the non-complying candidate service should be exempt from the predetermined service selection policy (714) is typically carried out by requesting opinions as to exemption from one or more business information sources, such as various relevant stakeholders, consultants in a consulting group, appropriate subject matter experts, or other business information sources and determining whether the non-complying service should be exempt in dependence upon those opinions. Determining (728) whether the non-complying candidate service should be exempt from the predetermined service selection policy (714) is typically dependent upon factors such as the ownership of the service, the business functionality of the service, the business usefulness of the service and other factors that will occur to those of skill in the art.

Determining (728) whether the non-complying candidate service should be exempt from the predetermined service selection policy (714) may be carried out by one or more business members, one or more governance software applications, web servers, spreadsheets, databases, computers, networks, aggregations of software and hardware, and other tools as will occur to those of skill in the art.

If the non-complying candidate service should be exempt from the predetermined service selection policy, the method of FIG. 7 includes determining (730) whether the non-complying candidate service is viable. Determining (730) whether the non-complying candidate service is viable further comprises determining whether the service will perform appropriately in the SOA and often determining whether the exempt service is sufficiently well documented to be included in the SOA with the other selected services. Determining (730) whether the non-complying candidate service is viable may be carried out by one or more business members, one or more governance software applications, web servers, spreadsheets, databases, computers, networks, aggregations of software and hardware, and other tools as will occur to those of skill in the art.

If the non-complying candidate service is viable, the method of FIG. 7 includes selecting (732) the non-complying and exempt candidate service as a service available for the SOA and communicating (726) the identification of that selected service to relevant stakeholders in the SOA. Selecting (732) the non-complying and exempt candidate service as a service available for the SOA includes identifying and documenting the selected candidate service as a service selected as available for the SOA. Selecting (732) the non-complying and exempt candidate service as a service available for the SOA may be carried out by one or more business members, one or more governance software applications, web servers, spreadsheets, databases, computers, networks, aggregations of software and hardware, and other tools as will occur to those of skill in the art.

As mentioned above, communicating (726) the identification of that selected service (724) to relevant stakeholders in the SOA is typically carried out in accordance with a communication plan and the identified selected service is typically communicated to the appropriate stakeholders and often communicated by the process owner. Communicating (726) the identification of that selected service (724) to relevant stakeholders in the SOA may be carried out by one or more business members, one or more governance software applications, web servers, spreadsheets, databases, computers, networks, aggregations of software and hardware, and other tools as will occur to those of skill in the art.

The method of FIG. 7 also includes capturing (736) evaluation metrics describing the relationships between identified candidate services (718) and ultimately selected services (724) available for the SOA. Capturing (736) evaluation metrics describing the relationships between identified candidate services (718) and ultimately selected services (724) available for the SOA may include surveys of business members involved in carrying out governance processes, data recorded by computer systems identifying statistics describing the business functions and ownership of the services, metrics describing the amount of time required to make a decision for exemption of one or more services, the number of parties involved in the decisions regarding exemption of one or more services and so on as will occur to those of skill in the art. Capturing (736) evaluation metrics describing the relationships between identified candidate services (718) and ultimately selected services (724) available for the SOA may be carried out by one or more business members, one or more governance software applications, web servers, spreadsheets, databases, computers, networks, aggregations of software and hardware, and other tools as will occur to those of skill in the art.

As mentioned above, the method of FIG. 7 includes identifying (712) in dependence upon the set of input parameters one or more candidate services for the SOA available in existing SOA business applications. For further explanation, FIG. 8 sets forth a flow chart illustrating an exemplary method for identifying (712) in dependence upon the set of input parameters one or more candidate services for the SOA available in existing SOA business applications. The method of FIG. 8 includes determining (802) whether each potential candidate service available in existing SOA business applications are identified in accordance with predetermined selection standards (810). Predetermined selection standards (810) typically define well-known SOA service identification methods such as for example, those using the Service Oriented Modeling and Architecture (‘SOMA’) methodology. SOMA includes methodology that often consists of a combination of top-down, bottom-up, and middle-out techniques of domain decomposition, existing asset analysis, and goal-service modeling as discussed below with reference to FIG. 9.

If each potential candidate services available in existing SOA business applications is identified in accordance with predetermined selection standards (810), the method of FIG. 8 includes identifying (804) that service as a candidate service for the SOA. If each potential candidate services available in existing SOA business applications is not identified in accordance with predetermined selection standards (810), the method of FIG. 8 includes determining (806) whether the service can be identified using predetermined selection standards (810). If the service can be identified using predetermined selection standards (810), the method of FIG. 8 includes identifying (804) that service as a candidate service for the SOA. If the service can not be identified using predetermined selection standards (810), the method of FIG. 8 includes not including (808) that service in the SOA.

For further explanation, FIG. 9 sets forth a block diagram of additional aspects of identifying (712) in dependence upon the set of input parameters one or more candidate services available for the SOA in existing SOA business applications according to embodiments of the present invention. Identifying (712) in dependence upon the set of input parameters one or more candidate services available for the SOA in existing SOA business applications according to the method of FIG. 9 includes domain decomposition (902) and existing asset analysis (906). Domain decomposition (902) takes a top-down view, a blueprint of business use cases to provide the specification for business service identification. Domain decomposition includes the decomposition of the business domain into its functional areas and subsystems, including its flow or process decomposition into processes, sub-processes, and high-level business use cases. These use cases often identify good candidate services for business services exposed at the edge of the enterprise, or for those used within the boundaries of the enterprise across lines of business. Domain decomposition (902) may be carried out by one or more business members, one or more governance software applications, web servers, spreadsheets, databases, computers, networks, aggregations of software and hardware, and other tools as will occur to those of skill in the art.

Existing asset analysis (906) takes a bottom-up approach by analyzing existing systems. Existing systems are analyzed and selected as viable candidates for providing lower cost solutions to the implementation of underlying service functionality that supports the business process. In existing asset analysis, an SOA architect may analyze and leverage API's, transactions, and modules from legacy and packaged applications. In some cases, componentization of the legacy systems is needed to re-modularize the existing assets for supporting service functionality. Existing asset analysis (906) may be carried out by one or more business members, one or more governance software applications, web servers, spreadsheets, databases, computers, networks, aggregations of software and hardware, and other tools as will occur to those of skill in the art.

In the example of FIG. 9, identifying (712) in dependence upon the set of input parameters one or more candidate services available for the SOA includes goal-service modeling (904). Goal-service modeling is a middle-out method that ties services to goals and sub-goals, key performance indicators, and metrics. Goal-service modeling is use to validate and unearth other services not captured by either top-down or bottom-up service identification approaches. Goal-service modeling may be carried out by one or more business members, one or more governance software applications, web servers, spreadsheets, databases, computers, networks, aggregations of software and hardware, and other tools as will occur to those of skill in the art.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of governing service identification in a Service Oriented Architecture (‘SOA’) governance model, the method
receiving a set of input parameters for identifying candidate services for the SOA;
determining whether the set of input parameters comply with a predetermined input parameter validation policy;
if the set of input parameters comply with a predetermined input parameter validation policy, identifying in dependence upon the set of input parameters one or more candidate services available for the SOA in existing SOA business applications;
determining whether each candidate services available in existing SOA business applications complies with a predetermined service selection policy; and
if one of the candidate services available in existing SOA business applications complies with a predetermined service selection policy, selecting the candidate service as a service available for the SOA; and
communicating the identification of that selected service to relevant stakeholders in the SOA.

2. The method of claim 1 further comprising capturing evaluation metrics describing the relationships between identified candidate services and ultimately selected services available for the SOA.

3. The method of claim 1 wherein determining whether the set of input parameters comply with a predetermined input parameter validation policy further comprises determining whether the input parameters comply with a documentation standard.

4. The method of claim 1 wherein determining whether the set of input parameters comply with a predetermined input parameter validation policy further comprises determining whether the input parameters (704) comply with a documentation standard; and
if the input parameters do not comply with the documentation standard, correcting documentation of the input parameters.

5. The method of claim 1 further comprising determining whether the non-complying candidate service should be exempt from the predetermined service selection policy if one of the candidate services available in existing SOA business applications does not comply with a predetermined service selection policy; and
if the non-complying candidate service should be exempt from the predetermined service selection policy, determining whether the non-complying candidate service is viable; and
if the non-complying candidate service is viable, selecting the non-complying and exempt candidate service as a service available for the SOA and communicating the identification of that selected service to relevant stakeholders in the SOA.

6. The method of claim 1 wherein identifying in dependence upon the set of input parameters one or more candidate services for the SOA available in existing SOA business applications further comprises:
determining whether each potential candidate service available in existing SOA business applications are identified in accordance with predetermined selection standards; and
if each potential candidate services available in existing SOA business applications is identified in accordance with predetermined selection standards, identifying that service as a candidate service for the SOA.

7. The method of claim 1 wherein identifying in dependence upon the set of input parameters one or more candidate services for the SOA available in existing SOA business applications further comprises:
determining whether each potential candidate service available in existing SOA business applications are identified in accordance with predetermined selection standards; and
if each potential candidate services available in existing SOA business applications is not identified in accordance with predetermined selection standards, determining whether the service can be identified using predetermined selection standards; and
if the service can be identified using predetermined selection standards, identifying that service as a candidate service for the SOA.

8. The method of claim 1 wherein identifying in dependence upon the set of input parameters one or more candidate services available for the SOA in existing SOA business applications further comprises domain decomposition and existing asset analysis.

9. The method of claim 8 wherein identifying in dependence upon the set of input parameters one or more candidate services available for the SOA in existing SOA business applications further comprises goal-service modeling.

10. A system of governing service identification in a Service Oriented Architecture (‘SOA’) governance model, the system
means for receiving a set of input parameters for identifying candidate services for the SOA;
means for determining whether the set of input parameters comply with a predetermined input parameter validation policy;
means for identifying in dependence upon the set of input parameters one or more candidate services available for the SOA in existing SOA business applications if the set of input parameters comply with a predetermined input parameter validation policy;
means for determining whether each candidate services available in existing SOA business applications complies with a predetermined service selection policy; and
means for selecting the candidate service as a service available for the SOA if one of the candidate services available in existing SOA business applications complies with a predetermined service selection policy;and
means for communicating the identification of that selected service to relevant stakeholders in the SOA.

11. The system of claim 10 further comprising means for capturing evaluation metrics describing the relationships between identified candidate services and ultimately selected services available for the SOA.

12. The system of claim 10 wherein means for determining whether the set of input parameters comply with a predetermined input parameter validation policy further comprises means for determining whether the input parameters comply with a documentation standard.

13. The system of claim 10 wherein means for determining whether the set of input parameters comply with a predetermined input parameter validation policy further comprises means for determining whether the input parameters (704) comply with a documentation standard; and
means for correcting documentation of the input parameters if the input parameters do not comply with the documentation standard.

14. The system of claim 10 further comprising means for determining whether the non-complying candidate service should be exempt from the predetermined service selection policy if one of the candidate services available in existing SOA business applications does not comply with a predetermined service selection policy; and
means for determining whether the non-complying candidate service is viable if the non-complying candidate service should be exempt from the predetermined service selection policy; and
means for selecting the non-complying and exempt candidate service as a service available for the SOA and means for communicating the identification of that selected service to relevant stakeholders in the SOA if the non-complying candidate service is viable.

15. The system of claim 10 wherein means for identifying in dependence upon the set of input parameters one or more candidate services for the SOA available in existing SOA business applications further comprises:
means for determining whether each potential candidate service available in existing SOA business applications are identified in accordance with predetermined selection standards; and
means for identifying that service as a candidate service for the SOA if each potential candidate services available in existing SOA business applications is identified in accordance with predetermined selection standards.

16. The system of claim 10 wherein means for identifying in dependence upon the set of input parameters one or more candidate services for the SOA available in existing SOA business applications further comprises:
means for determining whether each potential candidate service available in existing SOA business applications are identified in accordance with predetermined selection standards; and
means for determining whether the service can be identified using predetermined selection standards if each potential candidate services available in existing SOA business applications is not identified in accordance with predetermined selection standards; and
means for identifying that service as a candidate service for the SOA if the service can be identified using predetermined selection standards.

17. The system of claim 10 wherein means for identifying in dependence upon the set of input parameters one or more candidate services available for the SOA in existing SOA business applications further comprises means for domain decomposition and means for existing asset analysis.

18. The system of claim 17 wherein means for identifying in dependence upon the set of input parameters one or more candidate services available for the SOA in existing SOA business applications further comprises means for goal-service modeling.
